(19) United States
(12) Patent Application Publication
(10) Pub. No.: US 2011/0291556 A1
(43) Pub. Date: Dec. 1, 2011

(54) GAS DISCHARGE LAMP

(75) Inventors: Lung CHEN, Hu-Kou (TW); Hui-Hsiang FENG, Hu-Kou (TW); Ya-Chuan YEH, Hu-Kou (TW)

(73) Assignee: Arclite Optronics Corp., Hu-Kou (TW)

(21) Appl. No.: 13/090,251

(22) Filed: Apr. 19, 2011

(30) Foreign Application Priority Data
May 26, 2010 (TW) 099209912

(51) Int. Cl. H01J 61/04

(52) U.S. Cl. 313/631

(57) ABSTRACT

A gas discharge lamp includes a lamp tube, two electrodes and an electron emitter. The lamp tube has a hermetic discharge chamber filled with a rare gas and two sealing neck portions. Each of the sealing neck portions has a metallic foil disposed therein. Each of the two electrodes includes an emitting part and a connecting part. The connecting part is connected to a metallic wire via the metallic foil. The metallic wire extends out of the sealing neck portion to form a circuit contact. The electron emitter is made of a conductive material and electrically connected to one of the electrodes. A portion of the electron emitter disposed in the hermetic discharge chamber, and a diameter of an end of the electron emitter in the hermetic discharge chamber is less than an outer diameter of the connecting part.

### FIELD OF THE INVENTION

The present invention relates to a gas discharge lamp, and more particularly to a high-pressure gas discharge lamp that is based on a high-pressure discharge principle to generate an electric arc in a lamp tube to emit light.

### BACKGROUND OF THE INVENTION

Generally, high-pressure gas discharge lamps include metal halide lamps, sodium lamps, mercury lamps, xenon lamps, car headlights and ceramic metal halide lamps. The lighting principle of the high-pressure gas discharge lamps is that, two working electrodes in a lamp tube discharge to generate electrons to excite gas in the lamp tube to emit light.

The conventional high-pressure gas discharge lamps have a characteristic of high brightness. However, the conventional high-pressure gas discharge lamps require a relatively high starting voltage. Typically, the starting voltage should be in a range from 10 to 15 kilovolts (KV) or be more 15 kilovolts.

To overcome the above drawbacks, Taiwan patent No. 200407935 discloses that an ultraviolet (UV) radiation source is provided to improve starting reliability of a gas discharge lamp. An inflatable chamber is disposed at a metallic foil in a hermetic neck part and is configured for serving as the UV light radiation source. However, the quality of the inflatable chamber is uncontrollable and an expansion space of the inflatable chamber is limited. Thus, the UV light generated is insufficient, which will affect the quality and the life span of the gas discharge lamp. In addition, because the length of the hermetic neck part is insufficient, the quality of the gas discharge lamp is instable and the life span of the gas discharge lamp is shortened.

### SUMMARY OF THE INVENTION

The present invention provides a gas discharge lamp, which has characteristics of fast starting, low starting voltage, long life span, and carrying out easily.

The present invention provides a gas discharge lamp, which includes a lamp tube, two electrodes and at least an electron emitter. The lamp tube includes a hermetic discharge chamber filled with a rare gas and two sealing neck portions connected to two opposite sides of the hermetic discharge chamber respectively. Each of the sealing neck portions has a metallic foil disposed therein. The two electrodes are disposed in the hermetic discharge chamber and face to each other. Each of the two electrodes includes an emitting part and a connecting part connected to the emitting part. The connecting part of each of the two electrodes is electrically connected to a metallic wire disposed in the corresponding sealing neck portion via the metallic foil located therebetween. The metallic wire extends out of the sealing neck portion to form a circuit contact. The electron emitter is disposed in the hermetic discharge chamber and electrically connected to one of the two electrodes. The electron emitter is made of a conductive material, and a diameter of an end of the electron emitter in the hermetic discharge chamber is less than an outer diameter of the connecting part of the electrode connected to the electron emitter.

In one embodiment of the present invention, the electron emitter is formed by a fine metallic wire, and the fine metallic wire is wrapped around and extends out of the emitting part of the electrode connected to the electron emitter.

In one embodiment of the present invention, the electrode connected to the electron emitter has an electron emitting region when being lighted, and the electron emitter is weld on a portion of the emitting part outside the electron emitting region of the electrode connected to the electron emitter or a portion of the connecting part outside the electron emitting region of the electrode connected to the electron emitter.

In one embodiment of the present invention, the electron emitter is integrally formed with the one of the two electrodes, and a shape of the end of electron emitter is selected from a group consisting of arc-shaped, angular, cone-shaped or burr-like.

In one embodiment of the present invention, the end of the electron emitter in the hermetic discharge chamber is either arc-shaped or angular.

In one embodiment of the present invention, the electron emitter is a thin disk-shaped conductor, the end of the electron emitter is an annular brim of the thin disk-shaped conductor, the annular brim is arc-shaped, and a diameter of an arc of the end of the electron emitter is either less than or equal to an outer diameter of the connecting part.

In one embodiment of the present invention, the electron emitter is located in the hermetic discharge chamber entirely, and the electron emitter is connected to either the emitting part or the connecting part of the one of the two electrodes.

In one embodiment of the present invention, only the end of the electron emitter is exposed and located in the hermetic discharge chamber.

In one embodiment of the present invention, the one end of the electron emitter is connected to the metallic foil in the corresponding sealing neck portion, and the other end of the electron emitter is located in the hermetic discharge chamber.

In one embodiment of the present invention, the one end of the electron emitter is connected to the metallic wire in the corresponding sealing neck portion, the electron emitter penetrates the lamp tube from an external into the hermetic discharge chamber so that the other end of the electron emitter is located in the hermetic discharge chamber.

In one embodiment of the present invention, at least an electron emitter comprises two electron emitters electrically connected to the two electrodes respectively.

In one embodiment of the present invention, the gas discharge lamp further includes a conductor. The conductor and the electron emitter are disposed at an identical side of the hermetic discharge chamber, the conductor is configured on an outside of a connecting portion of the hermetic discharge chamber and the one of the two sealing neck portions, and the conductor is electrically connected to the metallic wire in the other of the two sealing neck portions.

According to the gas discharge lamp of the present invention, because the diameter of the arc section of the end of the electron emitter is relatively less, a charge density on the arc section of the end a is much higher than that of the electrode and the body of the electron emitter when a power is applied to the gas discharge lamp. Consequently, relatively high electric-field is formed at the end, and electrons are drawn out from the end to generate a point discharge effect. Thus, the two electrodes can be rapidly conducted with each other due to electric breakdown, and an electric arc generated may reduce the time of the emitting part reaching the working temperature. And thus the starting time can be shortened, and the starting voltage of the gas discharge lamps can be decreased. In addition, because the electron emitter is connected to the electrode, a heat dissipating area of the electrode can be increased, thereby reducing a temperature of the electrode and increasing the life span of the gas discharge lamp.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic, cross-sectional view of a gas discharge lamp according to an embodiment of the present invention.

FIG. 2 is a schematic view of a gas discharge lamp, which illustrates each of two electrodes is electrically connected to an electron emitter according to another embodiment of the present invention.

FIG. 3 is a schematic view of an electron emitter according to an embodiment of the present invention.

FIG. 4 is a schematic view of an electron emitter according to another embodiment of the present invention.

FIG. 5 is a schematic cross-sectional view of a gas discharge lamp according to further another embodiment of the present invention.

FIG. 6 is a schematic view of an electron emitter according to further another embodiment of the present invention.

FIG. 7 is a schematic cross-sectional view of a gas discharge lamp according to still another embodiment of the present invention.

FIG. 8 is a schematic view of an electron emitter according to still another embodiment of the present invention.

FIG. 9 is a schematic view of an electron emitter according to yet another embodiment of the present invention.

FIG. 10 is a schematic view of an electron emitter according to also another embodiment of the present invention.

FIG. 11 is a schematic cross-sectional view of a gas discharge lamp according to yet another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

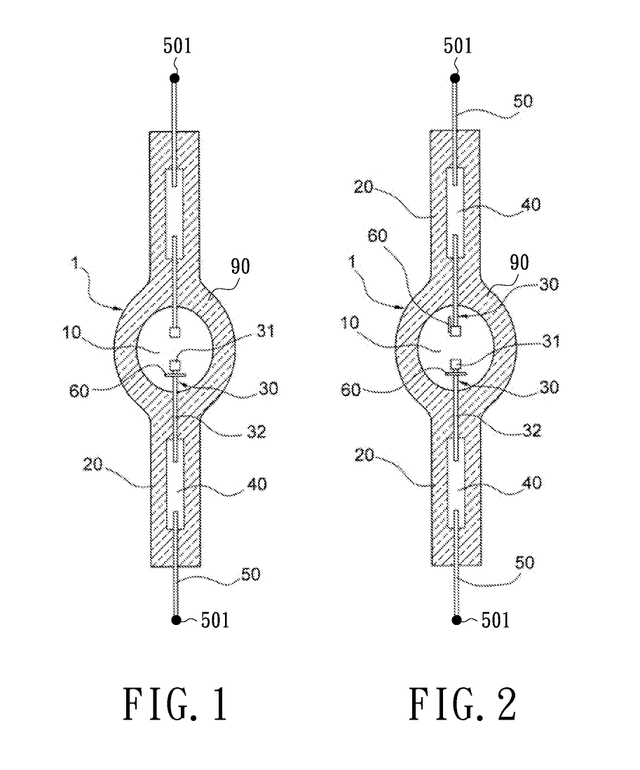

FIG. 1 is a schematic, cross-sectional view of a gas discharge lamp according to an embodiment of the present invention. Referring to FIG. 1, in the present embodiment, the gas discharge lamp 1 includes a lamp tube 90, two electrodes 30 and an electron emitter 60. The lamp tube 90 has a hermetic discharge chamber 10 and two sealing neck portions 20. The hermetic discharge chamber 10 is filled with at least one rare gas (not shown). The two sealing neck portions 20 face to each other and are respectively connected two opposite sides of the hermetic discharge chamber 10. Each of the electrodes 30 includes an emitting part 31 and a connecting part 32. A metallic foil 40 is disposed in each of the sealing neck portions 20. The metallic foil 40 is connected between the connecting part 32 of the corresponding electrode 30 and a metallic wire 50. The metallic wire 50 is disposed in each of the sealing neck portions 20 and extends out of the corresponding sealing neck portion 20 to form a circuit contact 501. The electron emitter 60 is made of a conductive material and is electrically connected to one of the two electrodes 30.

In an alternative embodiment, two electron emitters 60 are disposed in the gas discharge lamp 1, and two electron emitters 60 are respectively connected to the two electrodes 30, as shown in FIG. 2. The conductive material of the electron emitter 60 shown in FIGS. 1 and 2 can be a heat-resistant metallic material, such as tungsten (W), molybdenum (Mo), tantalum (Ta), niobium (Nb), rhenium (Re) and combination thereof In an alternative embodiment, the conductive material of the electron emitter 60 can be tungsten material containing thorium (Th) or thorium oxide (ThO₂). A percentage ratio of thorium (Th) or thorium oxide (ThO₂) is in a range from 0.1 to 5%. In an alternative embodiment, the conductive material of the electron emitter 60 can be tungsten material containing cerium (Ce) or cerium oxide (CeO). A percentage ratio of cerium (Ce) or cerium oxide (CeO) is in a range from 0.1 to 5%. In an alternative embodiment, the electron emitter 60 can be made of a metallic base material coated with an oxide. The metallic base material can be selected from a group consisting of tungsten (W), molybdenum (Mo), tantalum (Ta), niobium (Nb), rhenium (Re) and combination thereof, and the oxide can be selected from a group consisting of barium oxide, calcium oxide, strontium oxide and combination thereof In an alternative embodiment, the electron emitter 60 can be made of a metallic base material coated with an oxide. The metallic base material can be selected from a group consisting of tungsten (W), molybdenum (Mo), tantalum (Ta), niobium (Nb), rhenium (Re) and combination thereof The oxide includes a first oxide material and a second oxide material. The first oxide material can be selected from a group consisting of barium oxide, calcium oxide, strontium oxide and combination thereof, and the second oxide material is configured for acting as an active material and can selected from a group consisting of silicon oxide, magnesium oxide, zirconium oxide, aluminum oxide and combination thereof

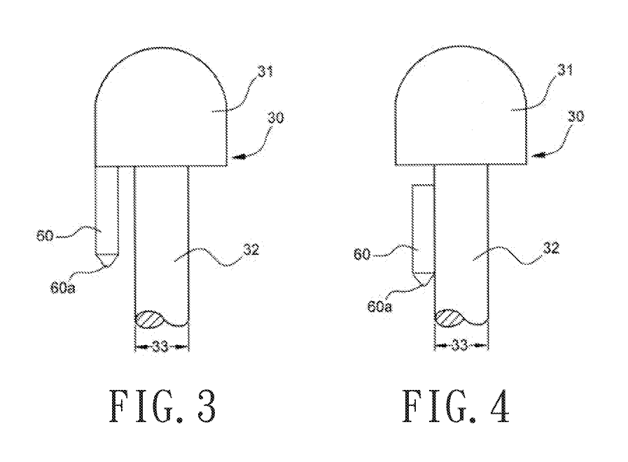

Shapes of the electron emitter 60 and connection structures between the electrode 30 and the electron emitter 60 can be designed according to various requirements, and some examples will be described as follows. In a first example, referring to FIG. 3, the electron emitter 60 is rod-shaped and is connected to the emitting part 31. A diameter of the electron emitter 60 is less than a maximum outer diameter 33 of the connecting part 32. An end 60a of the electron emitter 60 is cone-shaped, which is used to generate a point discharge effect. In other embodiments, the end 60a of the electron emitter 60 can be arc-shaped, angular or burr-like or a rough surface. A diameter of the arc section of the end 60a is less than the maximum outer diameter 33 of the connecting part 32.

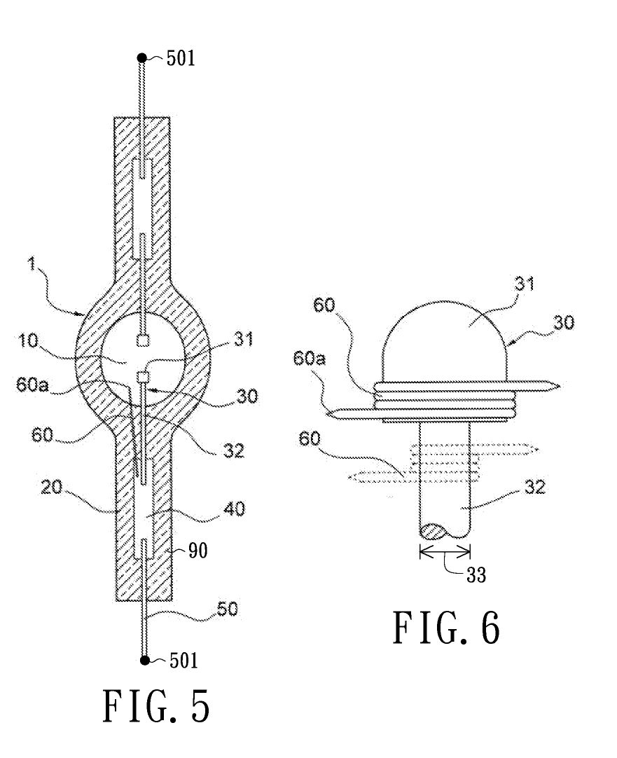

In a second example, referring to FIG. 4, the electron emitter 60 is connected to the connecting part 32. In a third example, referring to FIG. 5, one end of the electron emitter 60 is connected to the metallic foil 40 in the sealing neck portion 20, the other end of the electron emitter 60 is located in the hermetic discharge chamber 10 of the lamp tube 90. Thus, the electron emitter 60 is electrically connected to the electrode 30, and at least a portion of the electron emitter 60 (e.g., the end 60a) is exposed and located in the hermetic discharge chamber 10.

In a fourth example, referring to FIG. 6, the electron emitter 60 is wire-like. A diameter of the electron emitter 60 is less than a maximum outer diameter 33 of the connecting part 32. An end 60a of the electron emitter 60 can be arc-shaped, angular, cone-shaped, burr-like or a rough surface, which is used to generate a point discharge effect. A diameter of an arc section of the end 60a is less than the maximum outer diameter 33 of the connecting part 32. The electron emitter 60 can be wrapped around either the emitting part 31 or the connecting part 32 (see dotted line as shown in FIG. 6). It is noted that the electron emitter 60 can be welded on either the emitting part 31 or the connecting part 32 (not shown in FIG. 6 but similar to the manners shown in FIGS. 3 and 4). Additionally, one end of the electron emitter 60 can be connected to the metallic foil 40 in the sealing neck portion 20, the other end of the electron emitter 60 is located in the hermetic discharge chamber 10 of the lamp tube 90 (not shown in FIG. 6 but similar to the manners shown in FIG. 5). Thus, the electron emitter 60 is electrically connected to the electrode 30, and at least a portion of the electron emitter 60 (e.g., an end 60a) is exposed and located in the hermetic discharge chamber 10.

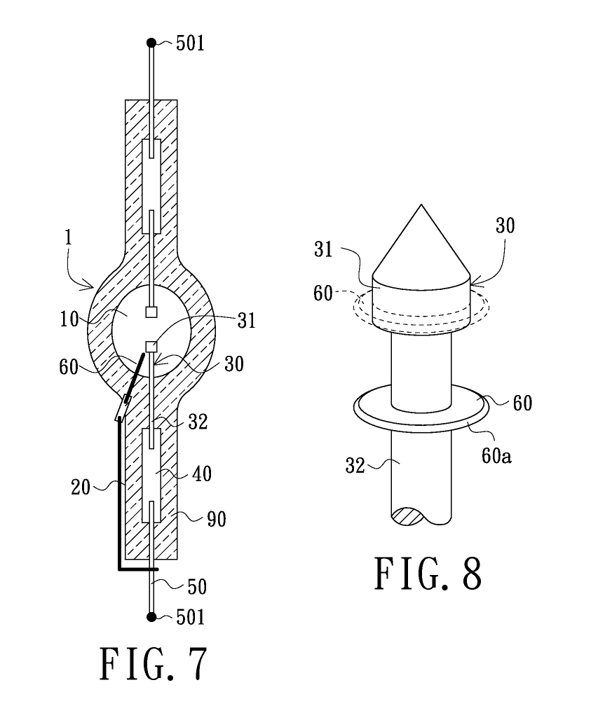

In a fifth example, referring to FIG. 7, the electron emitter 60 can be either rod-shaped or wire-like. One end of the electron emitter 60 is connected to a metallic wire 50, and the other end of the electron emitter 60 is located in the hermetic discharge chamber 10. The electron emitter 60 penetrates a lamp tube 90 from the external into the hermetic discharge chamber 10 of the lamp tube 90. Thus, the electron emitter 60 is electrically connected to the electrode 30, and at least a portion of the electron emitter 60, for example, an end 60a, is exposed and located in the hermetic discharge chamber 10. The end 60a in the hermetic discharge chamber 10 is used to generate a point discharge effect.

In a sixth example, referring to FIG. 8, the electron emitter 60 can be thin disk-shaped conductor. An end 60a of the electron emitter 60 is an annular brim of the thin disk-shaped conductor, and is arc-shaped or angular. A diameter of an arc section of the end 60a is less than a maximum outer diameter 33 of the connecting part 32. The end 60a is used to generate a point discharge effect. The electron emitter 60 can be welded on the emitting part 31 or the connecting part 32 of the electrode 30. Thus, the electron emitter 60 is electrically connected to the electrode 30 and is exposed and located in a hermetic discharge chamber 10 entirely.

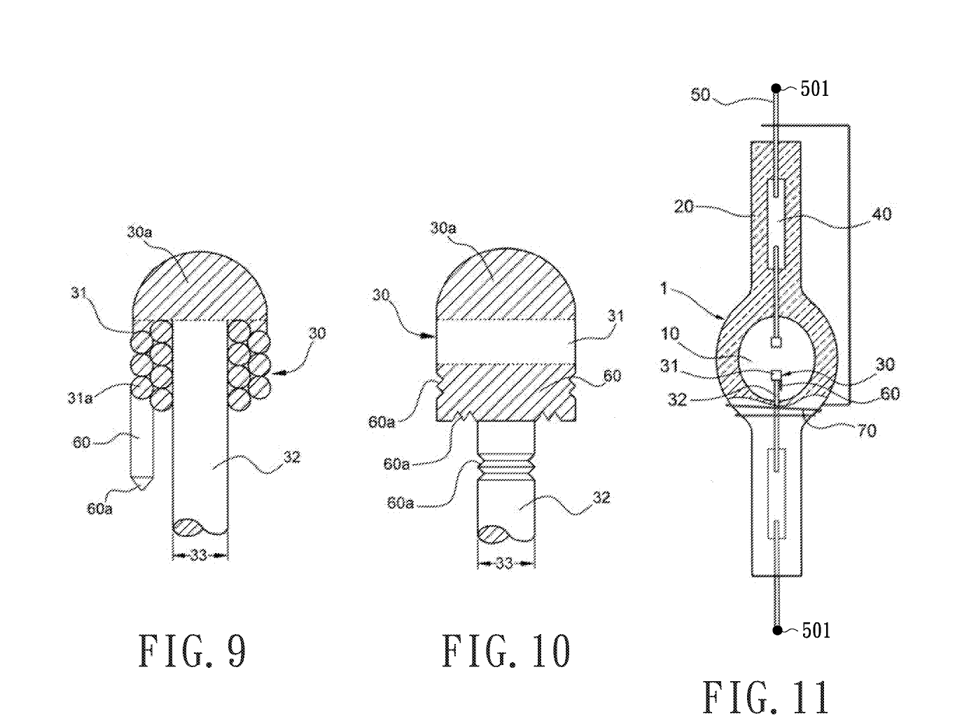

In a seventh example, referring to FIG. 9, the electron emitter 60 is formed by a fine metallic wire 31a that is wrapped around the emitting part 31 of the electrode 30. That is, the fine metallic wire 31a is extended out of the emitting part 31 to form the electron emitter 60. The fine metallic wire 31a is made of tungsten. Thus, the electron emitter 60 is electrically connected to the electrode 30 and is exposed and located in a hermetic discharge chamber 10 entirely.

In an eighth example, referring to FIG. 10, an electron emitter 60 is integrally formed with an electrode 30. The electrode 30 has an electron emitting region 30a while the electrode 30 is lighted. One end 60a of electron emitter 60 is disposed on a surface of an emitting part 31 outside the electron emitting region 30a or a surface of a connecting part 32 outside the electron emitting region 30a. The end 60a can be arc-shaped, angular, cone-shaped or burr-like, which is used to generate a point discharge effect. Thus, the electron emitter 60 is electrically connected to the electrode 30 and is exposed and located in a hermetic discharge chamber 10 entirely.

In the embodiments as shown in FIGS. 1 to 10, the gas discharge lamps at least have the following advantages. Because the diameter of the arc section of the end 60a of the electron emitter 60 is relatively less, a charge density on the arc section of the end 60a is much higher than that of the electrode 30 and the body of the electron emitter 60 when a power is applied to the gas discharge lamp. Consequently, relatively high electric-field is formed at the end 60a, and electrons are drawn out from the end 60a to generate a point discharge effect. Thus, the two electrodes 30 can be rapidly conducted with each other due to electric breakdown, and an electric arc generated may reduce the time of the emitting part 31 reaching the working temperature. And thus the starting time can be shortened, and the starting voltage of the gas discharge lamps can be decreased. In addition, because the electron emitter 60 is connected to the electrode 30, a heat dissipating area of the electrode 30 can be increased, thereby reducing a temperature of the electrode 30 and increasing the life span of the gas discharge lamp.

Referring to FIG. 11, in another embodiment, the gas discharge lamp 1 further includes a conductor 70. The conductor 70 can be configured on an outside of a connecting potion of the hermetic discharge chamber 10 and the sealing neck portion 20. It is noted that, the conductor 70 and the electron emitter 60 are located at an identical side of the hermetic discharge chamber 10. In the present embodiment, the conductor 70 is a metallic wire. In an alternative embodiment, the conductor 70 can be made of a conductive material, which is coated on an outside surface of the lamp tube. The conductor 70 is electrically connected to a metallic wire 50 in another sealing neck portion 20 on another side of the of the hermetic discharge chamber 10. Thus, a relatively high voltage difference can be generated between the conductor 70 and the electron emitter 60 when a power is applied to the gas discharge lamp. Therefore, the electron activity can be improved effectively, thereby reducing the starting time and decreasing the starting voltage.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A gas discharge lamp, comprising:
a lamp tube, comprising:
a hermetic discharge chamber filled with at least one rare gas; and
two sealing neck portions connected to two opposite sides of the hermetic discharge chamber respectively, each of the sealing neck portions having a metallic foil disposed therein;
two electrodes, disposed in the hermetic discharge chamber, the two electrodes facing to each other, each of the two electrodes comprising:
an emitting part; and
a connecting part connected to the emitting part;
wherein the connecting part of each of the two electrodes is electrically connected to a metallic wire disposed in the corresponding sealing neck portion via the metallic foil located therebetween, and the metallic wire extends out of the sealing neck portion to form a circuit contact; and
at least an electron emitter, disposed in the hermetic discharge chamber and electrically connected to one of the two electrodes, the electron emitter being made of a conductive material, and a diameter of an end of the electron emitter in the hermetic discharge chamber being less than an outer diameter of the connecting part of the electrode connected to the electron emitter.

2. The gas discharge lamp according to claim 1, wherein the electron emitter is formed by a fine metallic wire, and the fine metallic wire is wrapped around and extends out of the emitting part of the electrode connected to the electron emitter.

3. The gas discharge lamp according to claim 1, wherein the electrode connected to the electron emitter has an electron emitting region when being lighted, and the electron emitter is weld on a portion of the emitting part outside the electron emitting region of the electrode connected to the electron emitter or a portion of the connecting part outside the electron emitting region of the electrode connected to the electron emitter.

4. The gas discharge lamp according to claim 1, wherein the electron emitter is integrally formed with the one of the two electrodes, and a shape of the end of electron emitter is selected from a group consisting of arc-shaped, angular, cone-shaped or burr-like.

5. The gas discharge lamp according to claim 1, wherein the end of the electron emitter in the hermetic discharge chamber is either arc-shaped or angular.

6. The gas discharge lamp according to claim 1, wherein the electron emitter is a thin disk-shaped conductor, the end of the electron emitter is an annular brim of the thin disk-shaped conductor, the annular brim is arc-shaped, and a diameter of an arc of the end of the electron emitter is either less than or equal to an outer diameter of the connecting part.

7. The gas discharge lamp according to claim 1, wherein the electron emitter is located in the hermetic discharge chamber entirely, and the electron emitter is connected to either the emitting part or the connecting part of the one of the two electrodes.

8. The gas discharge lamp according to claim 1, wherein only the end of the electron emitter is exposed and located in the hermetic discharge chamber.

9. The gas discharge lamp according to claim 1, wherein one end of the electron emitter is connected to the metallic foil in the corresponding sealing neck portion, the other end of the electron emitter is located in the hermetic discharge chamber.

10. The gas discharge lamp according to claim 1, wherein one end of the electron emitter is connected to the metallic wire in the corresponding sealing neck portion, the electron emitter penetrates the lamp tube from an external into the hermetic discharge chamber so that the other end of the electron emitter is located in the hermetic discharge chamber.

11. The gas discharge lamp according to claim 1, wherein at least an electron emitter comprises two electron emitters electrically connected to the two electrodes respectively.

12. The gas discharge lamp according to claim 1, further comprising a conductor, wherein the conductor and the electron emitter are disposed at an identical side of the hermetic discharge chamber, the conductor is configured on an outside of a connecting portion of the hermetic discharge chamber and the one of the two sealing neck portions, and the conductor is electrically connected to the metallic wire in the other of the two sealing neck portions.

13. A gas discharge lamp, comprising:
a lamp tube comprising:
a hermetic discharge chamber having a first side and a second side opposite to the first side;
a first sealing neck portion connected to the first side of the hermetic discharge chamber; and
a second sealing neck portion connected to the second side of the hermetic discharge chamber;
a first electrode disposed in the hermetic discharge chamber and electrically connected to a first contact point formed on the first sealing neck portion;
a second electrode disposed in the hermetic discharge chamber and electrically connected to a second contact point formed on the second sealing neck portion, wherein the second electrode faces to the first electrode, and each of the first electrode and the second electrode comprises an emitting part and a connecting part connected to the emitting part; and
a first electron emitter disposed in the hermetic discharge chamber and electrically connected to the connecting part of the first electrode, the first electron emitter being made of a conductive material, and a diameter of an end of the first electron emitter in the hermetic discharge chamber being less than an outer diameter of the connecting part of the first electrode.

14. The gas discharge lamp according to claim 13, further comprising:
a first metallic wire disposed in the first sealing neck portion and extending out of the first sealing neck portion to form the first circuit contact;
a first metallic foil disposed in the first sealing neck portion and connected between the first metallic wire and the connecting part of the first electrode;
a second metallic wire disposed in the second sealing neck portion and extending out of the second sealing neck portion to form the second circuit contact; and
a second metallic foil disposed in the second sealing neck portion and connected between the second metallic wire and the connecting part of the second electrode.

15. The gas discharge lamp according to claim 13, wherein the first electron emitter is formed by a fine metallic wire, and the fine metallic wire is wrapped around and extends out of the emitting part of the first electrode.

16. The gas discharge lamp according to claim 13, wherein the first electrode has an electron emitting region when being lighted, and the first electron emitter is weld on either a portion of the emitting part outside the electron emitting region of the first electrode or a portion of the connecting part outside the electron emitting region of the first electrode.

17. The gas discharge lamp according to claim 13, wherein the first electron emitter is integrally formed with the first electrode, and a shape of the end of the first electron emitter is selected from a group consisting of arc-shaped, angular, cone-shaped or burr-like.

18. The gas discharge lamp according to claim 13, wherein either the first electron emitter is located in the hermetic discharge chamber entirely or only the end of the first electron emitter is exposed and located in the hermetic discharge chamber.

19. The gas discharge lamp according to claim 13, further comprising a second electron emitter disposed in the hermetic discharge chamber and electrically connected to the connecting part of the second electrode, the second electron emitter being made of a conductive material, and a diameter of an end of the second electron emitter in the hermetic discharge chamber being less than an outer diameter of the connecting part of the second electrode.

20. The gas discharge lamp according to claim 14, further comprising a conductor, wherein the conductor and the first electron emitter are disposed at the first side of the hermetic discharge chamber, the conductor is configured on an outside of a connecting portion of the hermetic discharge chamber and the first sealing neck portion, and the conductor is electrically connected to the second metallic wire in the second sealing neck portion.
